(19) United States
(12) Patent Application Publication
(10) Pub. No.: US 2006/0104433 A1
(43) Pub. Date: May 18, 2006

(54) Call center campaign system

(76) Inventors: Jason Dean Simpson, Phoenix, AZ (US); Neil Thomas Peiffer JR., Phoenix, AZ (US)

Correspondence Address: INTER-TEL, INC., 7300 WEST BOSTON STREET, CHANDLER, AZ, 85226, US

(21) Appl. No.: 10/992,188

(22) Filed: Nov. 18, 2004

(51) Int. Cl. H04M 3/00; H04M 5/00

(52) U.S. Cl. 379/266.07; 379/265.02

(57) ABSTRACT

A call center campaign system is disclosed that permits a campaign agent to participate in a campaign upon a review of the agent's skills set. In one embodiment the skills set is stored on an portable electronic ID tag and is coupled to an agent port. Caller ID information is stored for each specific campaign and is provided such that the information can be displayed on the target device. Communication between the target and the agent is connected to the agent port if the agent is eligible and available to participate in the campaign. In one particular embodiment, the agent is eligible if there is a match between the agent's skills set and a preset business rating (BIR) associated with the campaign.

### FIELD OF THE INVENTION

The present invention relates generally to a call center campaign system.

### BACKGROUND OF THE INVENTION

Call centers are typically large communication centers with multiple agents assigned to field inbound and outbound communications with a particular group of targets. In a single call center location, agents may be available to receive and place calls on behalf of an institution that is principally located in another state, or even another country. The call center is generally capable of handling several institutions at the same time. Institutions usually contract with the call center to act as a representative of the institution for a limited purpose, such as receiving communications based on a promotional mailing or placing calls to targets soliciting a particular promotion. Often times, the same call center will handle a variety of tasks for an institution, such as fielding calls for a promotion as well as fielding calls for collection of accounts. In some cases, the same agent may be qualified to respond to several types of calls, e.g., promotional and collections, and in other cases, agents are restricted to a single type of call.

Campaigns are used by the call center to denote a particular task and/or group of targets for a particular institution. For example, the call center may have a collections campaign intended for calls to be placed to overdue accounts for a banking institution. The call center may also have a home equity campaign for the same banking institution that is intended to receive calls based on a prior solicitation for lending. Generally speaking, the campaign includes a group of selected targets (phone numbers, addresses, names, email, etc.) that the institution and/or the call center have designated as contacts for the task at hand.

While call centers have proven to be quite efficient at fielding large volumes of communications on behalf of institutions, there are shortcomings. Call centers generally employ large numbers of agents with varying levels of skill. Less experienced agents may not feel comfortable doing collections or may not have the expertise to handle highly complex solicitations. On the other hand, some agents may be well trained and capable of handling varying levels of communications with the target. Therefore, a system is needed to assess each agent with a skills set and permit the agent to field communications based upon their individual skills.

Another problem facing call centers, and the like, is the inability to keep all the agents active during their working hours. For instance, several campaigns may be running simultaneously, yet unless the system is aware that a particular agent is capable of handling communications pertaining to a running campaign, the agent may be idle. Often times agents are assigned to a single campaign and unless there is a waiting communication, the agent will be idle even though there are waiting communications for other campaigns. Thus, a system is needed to assess each campaign with a business rating to facilitate the handling of communications to the agents. Additionally, it would be beneficial to match communications to an agent using the business rating associated with the campaign and the skills set of the agent.

Yet another problem is the inability for agents to move around within the call center and beyond. For security reasons, agents generally use a login or password-protected means to inform the system that they are reporting for duty and ready to field communications. Often times the login is to a stationary device, such as a computer station or desktop endpoint. When the agent leaves his station, such as to use the restroom, he is required to logout or inactivate his station so communications will not be received to an empty desk. U.S. Pat. No. 5,901,209 issued to Tannenbaum et al. on May 4, 1999 attempts to solve some of these immobility problems by allowing the agents to remotely field calls by calling into the system, e.g., from a home phone, and providing an access code. A predictive dialer is used to place calls for agents geographically separated form both the network and other agents. However, Tannenbaum fails to address some of the other problems addressed above, such as permitting agents to field communications based upon their skills set and matching the skills set to a campaign business rating.

### SUMMARY OF THE INVENTION

A call center campaign system having an agent port in network communication with a central server and a portable electronic ID tag coupled to the agent port. The ID tag includes stored data specific to a campaign agent including a skills set of the agent. The central server being coupled to a database having a campaign stored thereon. The campaign including at least one target address, a caller identification specific to the campaign to be provided to the target address, and a preset business rating specific to the campaign. The server connects the target address to the agent port if there is a match between the skills set of the agent and the preset business rating of the campaign.

A method for fielding campaign calls in a call center includes storing, on a portable electronic ID tag, a skills set of the types of permitted campaign calls for a campaign agent and coupling the ID tag to a network port. The skills set from the ID tag is reviewed for a match to a campaign call, and if a match is found, the campaign call is routed to the network port.

A specific embodiment for an outbound call campaign system in a call center includes an agent port in network communication with a central server and the server coupled to a database having a campaign stored thereon. The campaign including at least one target address, a caller identification specific to the campaign to be provided to the target address, and a preset business rating specific to the campaign. The server selects the caller identification based upon the preset business rating for the campaign and connects the agent port to the target address.

A method for outbound call campaign, having at least one target telephone number stored in a campaign database, includes reviewing an agent skills set provided from a portable electronic ID tag at an agent port, and permitting an agent to participate in the campaign based upon the agent skills set. Placing a call to a target, providing a predetermined caller identification associated with the campaign to the target, and connecting the call to the agent port.

In another method for an outbound call campaign, having at least one target number stored in a campaign database, the method includes detecting an agent is attempting to log in to participate in the outbound call campaign at an agent port, and permitting the agent to participate in the campaign based upon a match between a skills set associated with the agent and a preset business rating associated with the campaign. Placing a call to a target, providing a predetermined caller identification associated with the campaign, and connecting the call to the agent port.

Various embodiments of the call campaign system and method include inserting the portable electronic ID tag into a headset that is coupled to the agent port. In additional embodiments, the ID tag includes biometric characteristic verification information.

### BRIEF DESCRIPTION OF THE DRAWINGS

These and other features, aspects, and advantages may be best understood by reference to the following description taken in conjunction with the accompanying drawings, wherein like reference numerals indicate similar elements:

FIG. 1 illustrates an exemplary architecture to support a call center campaign system in accordance with the various embodiments;

FIG. 2 is a flowchart of exemplary operations of a call center campaign system, in particular, for an outbound campaign;

FIG. 3 is a flowchart of exemplary operations of a call center campaign system, in particular, at agent log in; and

FIG. 4 is a flowchart of exemplary operations of a call center campaign system, in particular, for an inbound campaign.

### DETAILED DESCRIPTION

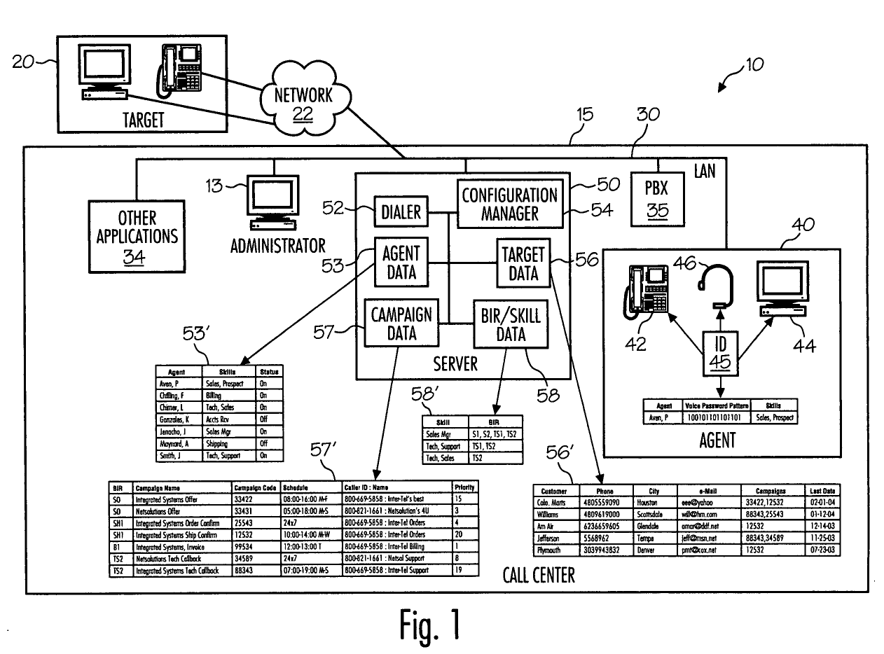

FIG. 1 illustrates an exemplary architecture 10 which may support a call center campaign system in accordance with the various embodiments. Exemplary campaign architecture or system 10 generally includes one or more targets 20, a communication network 22 and a call center 15. Target 20 includes an endpoint that call center 15 is in communication with. As shown in FIG. 1, target 20 may include a telephone, a computing device or any other communication device capable of communicating with call center 15. For ease of discussion, target 20 may be referred to as a telephone or “a call” to target 20, however it should be realized that the scope is not so limited. Communication between target 20 and call center 15 is over network 22, which may comprise any means of information communication, such as PSTN, the Internet, WAN, cellular stations and other wireless means, and any other suitable network for providing information communication between target 20 and call center 15. It should be recognized that various other components and/or systems may be included or needed to effectuate communication to target 20 that are not shown on FIG. 1 but are widely known and used in the communications industry.

As used herein, “call center” is intended to include a communications operation in which multiple agents field communications to and from targets. In addition, “call center” may also include a smaller organization in which a few or even a single agent is handling the communications. Regardless of the number of agents or size of operations, single or multiple campaigns may be running simultaneously.

Call center 15 generally comprises one or more agent ports 40, a central server 50, an administrator 13, various other applications 34, PBX system 35 (or the equivalent), and an internal network 30. Network or LAN 30 may be LAN, Ethernet, wired and wireless solutions, or any other communication medium suitable for routing data, information, video and/or voice between the various components of call center 15. Of course, it should be appreciated that LAN 30, or the equivalent, may be used for routing various other data, and the like, within the network and may facilitate communication among other components not shown in FIG. 1 or discussed herein.

PBX system 35, or the equivalent, may include, but not limited to, PBX systems, software controlled switches and hybrid telephone systems. PBX systems generally provide telephone and messaging services as needed to office users and their endpoints (such as agent port 40). In general, PBXs are telephone exchanges having special functions directed towards the communication needs of the users. Similarly, the PBX is any customer-owned switching apparatus that is used to connect real-time voice or multimedia communications from user-to-user (or endpoint-to-endpoint) regardless of the technology employed, such as time division multiplexing, packet switching, optical switching, pulse code modulation, internet protocols, ATM, or any combination thereof. Modern PBXs also provide integrated voice mail, hands free intercom calls, call center functions, complex system networks, and additional features using external computer control.

Administrator 13 comprises a computing device suitable for managing and directing campaign data on a bidirectional basis with server 50. Administrator 13 provides the data and information to server 50, such as campaign and agent data. In addition, administrator 13 monitors executed campaigns, agents' status', and general administrative reports. These supervisory and additional features and functions of administrator 13 will be discussed in more detail below.

Other applications 34 includes stored data which may be useful to the agent while fielding communications. This data may include historical payment information for a particular target, for example, account information, previous calling attempts and notes pertaining to a completed call. In one specific embodiment, other applications 34 includes target data that is routed to agent port 40 as a screen pop to facilitate fielding a communication with the target. As details of the system are discussed below, additional features of other applications 34 will be demonstrated.

Call center 15 further includes a central server 50 in communication with the various components and ports of call center 15. Central server 50 comprises hardware and software to facilitate the campaign objective of the system. For example, server 50 includes data, applications and configurations such as dialer 52, agent data 53, configuration manager 54, target data 56, campaign data 57 and BIR/skill data 58. Each of these particular data blocks will be discussed below. Campaign or predictive dialer 52 is used to place calls to targets. Dialing systems are known in the industry and generally initiate communication with the target so that only live answered calls are eventually connected to the agents. The dialers detect answering machines and often a pre-recorded message is transmitted to the target's machine, thus preserving valuable agent time. Busy and no answer calls can be retried automatically at some other future time. Dialer 52 receives commands from configuration manager 54 to include, but not limited to, dialing instructions, which targets should be contacted at what times, and transferring instructions when live communication to a target is completed. Target data 56 represents the contact information for the targets. Useful target information includes, but is not limited to, target data insert 56′, e.g., target name, access numbers, city of residence, and email address. It is also possible that a single target may be a contact in more than one campaign; therefore a list of the desired campaigns for the target may also be included.

Agent data 53 includes data pertaining to the agents associated with call center 15. For instance, useful data includes, but is not limited to, agent data 53′, e.g., the agent's name and whether or not the agent is available to field communications. In accordance with the various aspects of the call center campaign system, agent data 53′ includes a skills set for each agent. The skills set represents the types of communications the agent is qualified or trained to field. For instance, exemplary agent data 53′ lists agent name “Aven, P” with a skills set of “Sales, Prospect” meaning that agent Aven is available to field communications pertaining to sales and prospects. Thus, if an agent is needed to field a collection communication then agent Aven would not be dispatched. However, if an agent is needed to field a sales communication, then because agent Aven's status is “On” and Aven's skill set matches a sales communication, agent Aven would be a likely agent to field the communication. There are, however, other factors that are used by the campaign system to field communications to agents and will be discussed below.

Campaign data 57 includes data stored on or accessible by server 50 that is particular to each of the campaigns. Used herein, “campaign” has the industry-accepted meaning of a process to effectuate communication to a selected group of targets, often in the most efficient manner such as auto-dialing a list of numbers and using call progress analysis to connect an agent to a call as soon as ringing and/or an answer is detected. Additionally, “campaign” may include a mailing, emailing or advertisement to induce a selected group of targets to contact a call center. Useful campaign data includes, but is not limited to, campaign data 57′, e.g., campaign name, campaign code, campaign run times, campaign priority, and caller ID associated with the campaign. In accordance with the various aspects of the outbound campaign system, campaign data 57′ includes a preset business interaction rating (BIR) for each campaign. The BIR is often determined as a matter of business policy and is set up by an administrator who has the knowledge to decide how campaigns are to be classified. The BIR may be an arbitrary classification to denote the type of campaign, running time of campaign, or any other variable as decided or needed by an administrator. Often the same set of called parties can be served by different campaigns with correspondingly different BIRs.

BIR/skill data 58 includes a look-up table of agent skills sets and campaign BIRs such that the various skills are matched with the various BIRs. For instance, exemplary BIR/skill data 58′ illustrates that a BIR of “TS2” corresponds to a skill of “Tech, Sales” meaning that if a campaign is running that is a BIR of TS2, then an agent having a skills set of either tech or sales would be qualified to field the communications associated with that campaign. Additional features of BIR/skill data 58 will be discussed below in accordance with the various aspects of the outbound campaign system.

Although not shown on FIG. 1, it should be realized that other features may be present in server 50 to facilitate operations of a call center campaign system. Network interface hardware and/or software may be included in server 50 to permit coupling between server 50, LAN 30, network 22, and/or various other network communication systems. In other particular embodiments, there may be web applications, platforms and the like to facilitate communication between server 50 and the various other components. For example, administrator 13 may be remote from call center 15 and capable of transmitting data to server 50 over an Internet connection, web page, or similar electronic transmission means.

Agent port 40 includes a portable electronic ID tag 45, and at least one suitable endpoint device coupled to network 30 for bidirectional communication with the other systems of call center 15. As illustrated, suitable endpoints include, but not limited to, a desktop keyset 42, a computing device 44, and a headset or hands-free device 46. Other suitable endpoints include telephones (stationary and portable), personal digital assistants, pagers, wireless remote clients, messaging devices, and any other communication device capable of transmitting and receiving communication signals via network 30. Headset 46 may be in communication with network 30 directly or indirectly through another endpoint device. In particular embodiments, some or all of the endpoints may include a processor, memory, network interface, user I/O and power conversion, as needed, to establish the device as an operational unit or other real-time communicating device connected to network 30.

Portable electronic ID tag 45 comprises any portable electronic medium capable of data storage and retrieval. Suitable devices include, but not limited to, smart cards, removable jump drives, IC chips, and specially designed headset inserts. The various embodiments of an outbound campaign system include a portable electronic ID tag 45 capable of providing an authentication process, a means to permit agent travel about the call center 15 and beyond yet remain intact with system, and a technique to provide pertinent information concerning the agent's skills to the system. In one particular embodiment, portable ID tag 45 includes data stored thereon which contains personal identification information pertaining to a specific agent, such as name, skills set and authentication data. ID tag 45 may contain verification information that is physically saved in the tag for later verification against the agent's biometric characteristics. Suitable means of biometric verification include, but not limited to, voice-print patterns, fingerprint scans, iris pattern recognition, and brain wave scans. As illustrated in FIG. 1, exemplary ID tag 45 includes the agent's name, skills set and a binary voice-print pattern.

Portable electronic ID tag 45 may be coupled to network 30 directly or indirectly in any manner such that the data stored on tag 45 is transmitted from tag 45 to server 50. In one particular embodiment, ID tag 45 is inserted into headset 46 and the agent simply speaks a password into the headset microphone. The headset circuitry digitizes the voice and sends both the utterance and the stored voice print from tag 45 to server 50 (or wherever authentication is to take place) for comparison. If the voice patterns match or substantially match, authentication is complete and the agent's port can begin fielding communications. Various encryption methods and techniques may be used to disguise the voice-print in the event of an interception. In other embodiments, ID tag 45 may be inserted into a workstation 44 or keyset 42. Should ID tag 45 become lost, stolen or damaged, access to call center 15 may be disabled by administrator 13 to prevent fraudulent use.

A single agent may be issued multiple ID tags 45 with each tag having varying skills sets. In this manner, an agent may log out of the system, swap ID tags and log back in with the new tag containing a new set of skills. When the agent changes skill sets, the system logs them in under the new skills and processes communications to the agent accordingly.

A supervisor or system administrator may remotely (i.e., not in the same physical location as the agent's ID tag) view, erase, and store information on the agent's ID tag. In this manner, the supervisor can assess what skills are needed to be eligible to participate in a campaign and can modify one or more agent's skills set to increase the number of eligible agents.

The following flowcharts are provided to better understand the various steps of operation in a call center campaign system as described herein. It should be realized that the following description is not intended to be limiting but rather to provide a description of various embodiments and a best mode of operation. It should be appreciated that additional steps may occur that are not represented on the following flowcharts but are discussed in the conjoining text or elsewhere herein.

Moreover, there may be operations, functions, routines, and the like that are not depicted on the flows or elsewhere but are well understood in the industry as common actions for a communications system. Unless specifically stated, the order of the depicted and described operations is not limited to the description.

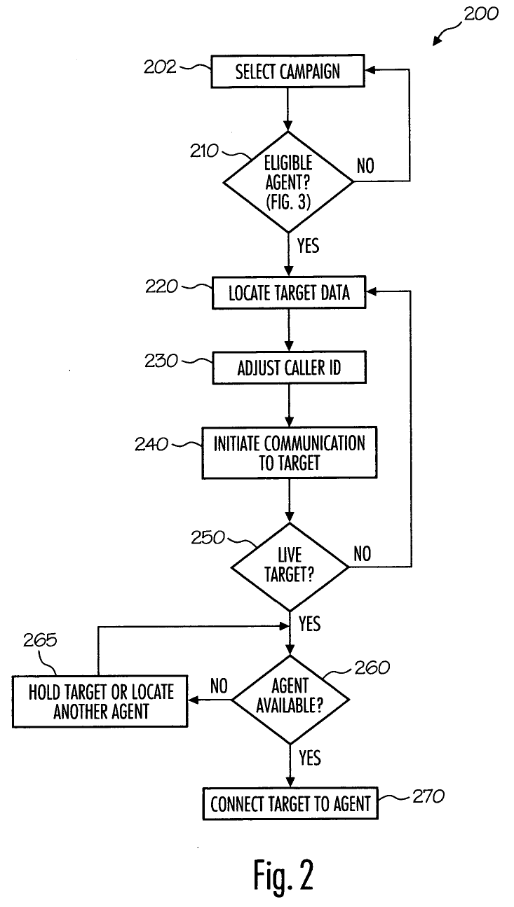

FIG. 2 is a flowchart 200 of exemplary operations in a call center campaign system and, in particular, for outbound campaigns (e.g., communications from call center 15 to target 20). Initially, a campaign is selected (step 202). With combined referenced to FIG. 1, campaign data 57′ may include a priority associated with each of the campaigns. The administrator 13 may select campaigns to run based upon this priority number and instruct the configuration manager 54 to queue the campaigns in order of descending priority. Alternatively, the administrator 13 may override the next queued campaign and select another campaign to run. In other embodiments, the campaigns may be associated with a schedule of what times of day and which days the campaign is to run. The schedule may also be a factor in the selection of the next campaign to run. Once a campaign is selected, the system determines if there are any eligible agents to participate in the campaign (step 210). If there are no agents logged in that meet the qualifications for the selected campaign, then the system may place the campaign back into the queue to be run at a later time and select a different campaign. Alternatively, the system may wait a period of time to see if any eligible agents log in.

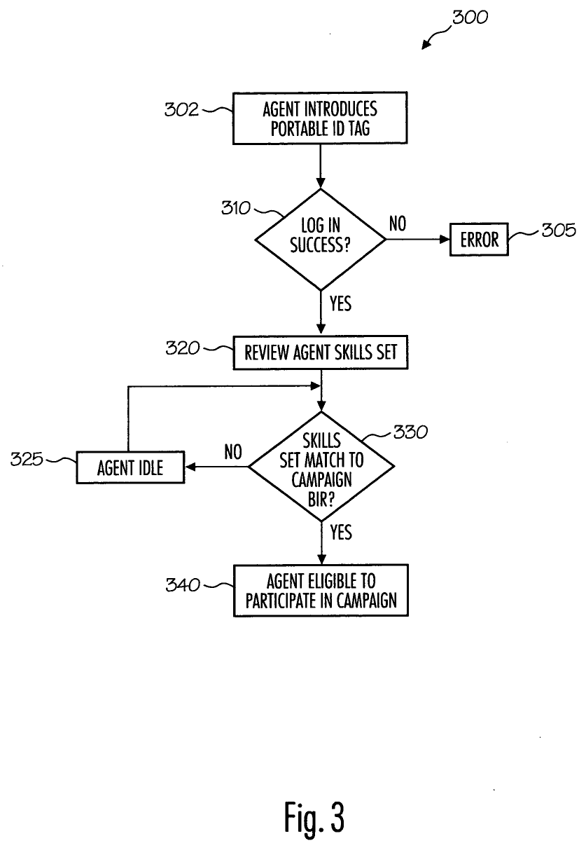

FIG. 3 is a flowchart 300 of the exemplary operations in a call center campaign system during agent log in. The agent may log into the system using a computing device and password or may simply key in a personal code at a desktop keyset. Regardless of the technique used by the agent to initiate the login sequence, in accordance with the various aspects of the outbound campaign system, the agent introduces a portable electronic ID tag to the system (step 302). As previously explained, the ID tag, such as ID tag 45, contains information pertinent to the agent and identifies the agent to the system and/or a specific device. In one particular embodiment, the agent may insert the ID tag into an electronic device, which initiates a biometric identification process. The system queries whether the agent's login was a success (step 310), e.g., the verification provided by the ID tag is matched with the system's records or is matched within a specific device, and if the login attempt failed, the system may report an error to the agent (step 305).

Assuming the agent login was successful, the system reviews the agent's skills set (step 320). In one particular embodiment, the system receives the agent's skills set information from the ID tag provided by the agent. The skills set is predetermined and saved in the ID tag by, for example, a system administrator or supervisor. Alternatively, the agent skill set may be stored in a database such as agent data 53. The system attempts to match the various skills sets of the agent with the BIRs of the campaigns currently running or set to run (step 330). This may be accomplished using a lookup table, such as table 58′. If a match between the agent's skill set and a BIR is found, then the agent is eligible to participate in the campaign corresponding to the matched BIR (step 340). In one particular embodiment, the system and/or device performs a periodic biometric verification to ensure the correct agent is still operating at the verified port. The system may sample the agent's voice pattern from the agent's port at periodic intervals and perform a test match against the stored voice print pattern.

If no match of the agent skills set and campaign BIR is found, then the agent may be idle (step 325) for a period of time until a new campaign is started. Alternatively, the administrator or supervisor may receive a message that the agent has logged in but there is not a currently running campaign in which the agent is eligible to participate in. To avoid long periods of downtime, the administrator may advise the agent to swap ID tags or may alter the agent's skills set and/or campaign.

Referring again to FIG. 2, assuming that the campaign has been selected and at least one agent is eligible to participate in the campaign, the system locates target data for the selected campaign (step 220). This may be accomplished using a table of target data such as data 56′. In one particular embodiment, a campaign is given a unique campaign code and each target is referenced with the campaign codes pertinent to that target. The system may cross-reference the campaign code with the targets until a match is found.

Preferably the outbound campaign system supports a system-wide open architecture interface (OAI) protocol to permit the manipulation of the caller ID information. Prior to initiating communication, the dialer sends a system OAI command to the system to update the caller ID information (step 230). The caller ID associated with the campaign is provided such that the target will be able to know who is attempting communication. In one particular embodiment, the administrator determines the caller ID (e.g., name, number or both) for each campaign and causes the ID information to be stored in campaign data 57. In another specific embodiment, the system retrieves a stored caller ID based upon the BIR for that specific campaign. The caller ID may change on a call-by-call basis depending upon the target, campaign and agent queued. Depending on the application and campaign, the caller ID information may be that of the agent.

Communication to the target is then initiated (step 240). In one embodiment, the campaign is a calling campaign. In this particular embodiment, configuration manager 54 may communicate with dialer 52 to send commands to PBX 35, which in turn transmits signals over network 22. The caller ID information associated with the campaign is sent to be displayed on the target's device. The target's number is dialed and the system queries whether a live target is reached (step 250). As is often the case with predictive dialers, the system determines whether a busy tone, answering machine, fax machine, dead line or an audible voice was reached at the target number. If no live connection was made, then the system disconnects and attempts to locate another target from the stored data (step 220). If a live target is reached, then the system queries whether an eligible agent is available (step 260). When an agent is busy fielding another communication, the system is able to recognize that the agent's port is not available to receive communications. Additionally, the agent may temporarily hold communications while on break or the like. If the agent's status is unavailable, the system may attempt to locate another available agent or place the target on hold (step 265). If, however, an eligible agent is available, the system connects the target to the agent's port (step 270). It should be realized that connection to the agent's port need not be to a stationary port, but rather the agent's port may be to a wireless port such as to a headset. Moreover, the port may be remote from call center 15.

In addition to connecting the target to the agent's port, the system may send commands to other applications 34 to serve data processing screen information to the agent's port and associated display device. This enables the system to initiate communication and coordinate the display of call processing and customer data at each agent port 40.

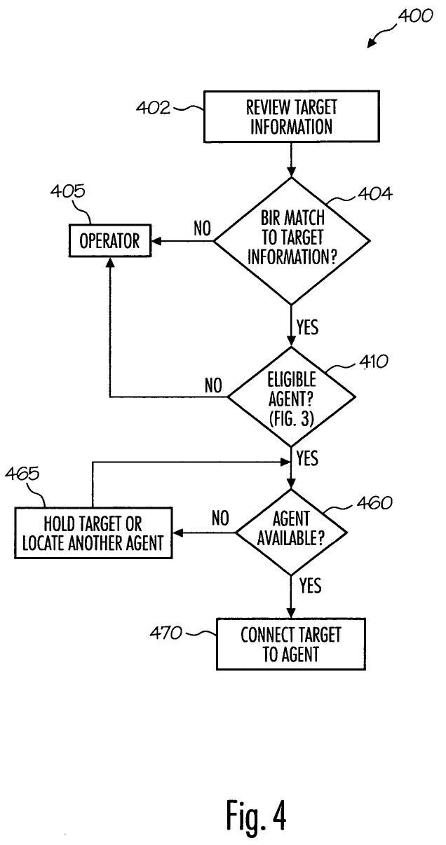

FIG. 4 is a flowchart 400 of the exemplary operations in a call center campaign system and, in particular, for inbound campaigns (e.g., communications from target 20 to call center 15). A communication from target 20 may be directed to institution that is being represented by call center 15 and, therefore, may be received at PBX 35 of call center 15. The incoming target information obtained by performing an analysis of the origin of the incoming call using information provided by the network, via Automatic Number Identification (ANI), Dialed Number Information Service (DNIS), or similar data is reviewed by the system (step 402). The system may be looking for various information such as calling party geographic location, the time of day, caller ID information (if present), which is used to determine how and where to route the incoming communication. In one particular embodiment of a call center campaign system, the system attempts to match the target information with a campaign BIR (step 404). As previously described, server 50 includes various data blocks including campaign data 57, target data 56, and BIR/skill data 58. Target data 56 and 56′ includes information specific to each target such as phone number, city, email address and campaign codes the target is a contact for. The system cross-references the incoming target information to stored data, such as target data 56 and 56′ and campaign data 57 and 57′, to determine if the target is a contact for a specific campaign by looking at the campaign BIR. It should be realized that an incoming campaign system may include various additional information stored in the data blocks to facilitate matching the target to a campaign.

If the system is unable to match the incoming target information to a campaign BIR, the target may be routed to an operator for further assistance (step 405). If, however, the system determines the target is a contact for at least one campaign, then the system queries whether an agent is eligible to field the incoming communication (step 410). This process is similar to the previously described process for FIG. 3. If there are no agents eligible to participate in a campaign for which the incoming target is a contact for, then the target may be routed to an operator for further assistance (step 405). The operator may be a live communication, a recording, a directory or any suitable means to assist the target in leaving a message or obtaining further assistance.

Assuming there is an agent eligible to field the communication, the system then queries whether the agent is available to receive the communication (step 460). If the agent is available, then the system connects the target to the agent (step 470) and if not, then the system may attempt to locate another agent or place the target on hold (step 465). Steps 460, 465 and 470 are similar to previously described steps 260, 265 and 270, respectively.

Presented herein are various embodiments, methods and techniques for an outbound campaign system, including the best mode. Having read this disclosure, one skilled in the industry may contemplate other similar techniques, modifications of structure, arrangements, proportions, elements, materials, and components that fall within the scope of the present invention. These and other changes or modifications are intended to be included within the scope of the disclosure, as expressed in the following claims.

1. A method for an outbound call campaign, the campaign including at least one target telephone number stored in a campaign database, the method comprising the steps of:
reviewing an agent skills set provided from a portable electronic ID tag at an agent port;
permitting an agent to participate in the campaign based upon the agent skills set;
placing a call to a target;
providing a predetermined caller identification associated with the campaign; and connecting the call to the agent port.

2. The method of claim 1 further comprising:
inserting the portable electronic ID tag in a headset; and
transmitting the skills set from the ID tag to a central server.

3. The method of claim 1 further comprising:
inserting the portable electronic ID tag in a headset;
substantially matching a biometric characteristic to data stored in ID tag; and
transmitting the skills set from the ID tag to a central server.

4. A method for an outbound call campaign, the campaign including at least one target number stored in a campaign database, the method comprising the steps of:
detecting an agent log in for participation in the outbound call campaign at an agent port;
permitting the agent to participate in the campaign based upon a match between a skills set associated with the agent and a preset business rating associated with the campaign;
placing a call to a target;
providing a predetermined caller identification associated with the campaign; and
connecting the call to the agent port.

5. The method of claim 4 wherein said detecting comprises coupling a portable electronic ID tag at the agent port.

6. The method of claim 4 further comprising providing the skills set from a portable electronic ID tag.

7. The method of claim 4 further comprising referring to a look up table comprising the skills and the business ratings.

8. A call center campaign system comprising:
an agent port in network communication with a central server;
a portable electronic ID tag coupled to the agent port, the ID tag comprising data specific to a campaign agent including a skills set of the agent; and
the central server coupled to a database having a campaign stored thereon, the campaign comprising at least one target address, a caller identification specific to the campaign to be provided to the target address, and a preset business rating specific to the campaign, the server connects the target address to the agent port if there is a match between the skills set of the agent and the preset business rating of the campaign.

9. The campaign system of claim 8 wherein the portable electronic ID tag is inserted into a headset and the headset is coupled to the agent port.

10. The campaign system of claim 8 wherein the ID tag comprises a biometric characteristic verification.

11. The campaign system of claim 8 wherein the biometric characteristic verification comprises a stored voice-print pattern of the campaign agent.

12. The campaign system of claim 8 wherein the server connects the target address to the agent port if there is a match between stored biometric data and a biometric characteristic of the campaign agent.

13. A method for fielding campaign calls in a call center, the method comprising:
storing on a portable electronic ID tag a skills set of the types of permitted campaign calls for a campaign agent;
coupling the portable electronic ID tag to a network port;
reviewing the skills set for a match to a campaign call; and
routing the campaign call to the network port if the campaign call matches the skills set from the portable electronic ID tag.

14. The method of claim 13 further comprising the campaign agent copying the skills set to a data file within a stationary device.

15. The method of claim 13 further comprising a supervisor remotely erasing the skills set stored on the ID tag.

16. The method of claim 13 wherein the storing of the skills set on the portable electronic ID tag is controlled by a supervisory function.

17. An outbound call campaign system for a call center, the system comprising:
an agent port in network communication with a central server;
the central server coupled to a database having a campaign stored thereon, the campaign comprising at least one target address, a preset business rating specific to the campaign, and a caller identification specific to the campaign to be provided to the target address; and
a target corresponding to the target address, the server selects the caller identification based upon the preset business rating and connects the agent port to the target.

18. The system of claim 17 wherein the server connects the agent port to the target if an agent is eligible to participate in the campaign.

19. The system of claim 18 wherein the agent is eligible if a skills set specific to the agent matches the preset business rating of the campaign.

20. The system of claim 17 further comprising a portable electronic ID tag coupled to the agent port and having a skills set specific to the agent stored thereon and the server connects the agent port to the target if there is a match between the skills set of the agent and the preset business rating of the campaign.
